(19) United States
(12) Patent Application Publication
(10) Pub. No.: US 2024/0345884 A1
(43) Pub. Date: Oct. 17, 2024

(54) IC Device Resource Sharing

(71) Applicants: Ashish Gupta, San Jose, CA (US); Rahul Pal, Bangalore (IN); Zhi-Hern Loh, Singapore (SG); Keong Hong Oh, Bayan Lepas (MY); Thuyet Gia Ngo, Bayan Lepas (MY)

(72) Inventors: Ashish Gupta, San Jose, CA (US); Rahul Pal, Bangalore (IN); Zhi-Hern Loh, Singapore (SG); Keong Hong Oh, Bayan Lepas (MY); Thuyet Gia Ngo, Bayan Lepas (MY)

(21) Appl. No.: 18/756,964

(22) Filed: Jun. 27, 2024

(51) Int. Cl. G06F 9/50

(52) U.S. Cl. CPC G06F 9/5027

(57) ABSTRACT

Systems or methods of the present disclosure may provide systems and techniques for sharing resources of an IC device between communications pipelines of the IC device. For example, a method may include: receiving a request from a first initiator component, the request associated with a first communication protocol; storing the request in a shared buffer; receiving a response from a first target component, the response associated with a second communication protocol; storing the response in the shared buffer; sending the request from the shared buffer to a second target component; and sending the response from the shared buffer to a second initiator component.

### BACKGROUND

The present disclosure relates generally to integrated circuit devices. More particularly, the present disclosure relates to distributing resources of an integrated circuit device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuit (IC) devices, such as field-programmable gate arrays (FPGAs), may include various components, such as memory devices, programmable logic blocks, processors, and accelerators. The components may be provisioned such that they may be accessed by various initiator components (e.g., processors, input/output devices) and/or tenants (e.g., users, applications) concurrently using various communications protocols. Further, separate interconnection resources of an IC device may be provisioned for each communication protocol, and each of the separate interconnection resources may include buffers, mapping tables, and the like for the communication protocol. However, provisioning separate resources may consume limited resources of the IC device.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is a block diagram of the system of FIG. 1, in which initiator components access target components using initiator bridges and target bridges of a universal bridge, in accordance with an embodiment of the present disclosure;

FIG. 5 is a block diagram of the system of FIG. 1, in which initiator bridges and target bridges access a shared buffer of the universal bridge, in accordance with an embodiment of the present disclosure;

FIG. 6 is a flow chart of a method for sharing resources of an IC device between communications pipelines of the IC device, in accordance with an embodiment of the present disclosure; and

FIG. 7 is a block diagram of a data processing system incorporating the integrated circuit system, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As mentioned, IC devices may include various target components, such as memory devices, programmable logic blocks, processors, and accelerators, and the target components may be provisioned such that they may be accessed by various initiator components concurrently using various communications protocols. Further, the IC device may include initiator bridges that each facilitate communications pipelines by, for example, routing communications and implementing access control, and each initiator bridge may access additional resources of the IC device to facilitate the pipeline. In a streaming protocol, for example, a streaming initiator bridge may access queueing buffers that manage communications (e.g., requests) from an initiator component to the target component. In an MMIO communications protocol, an MMIO initiator bridge may access destination mapping and routing tables, buffers that store responses from target components, quality of service (QOS) control tables, and the like to manage communications between initiator components and target components.

As may be appreciated, each communications pipeline and/or initiator bridge may require resources (e.g., memory resources) to store buffers, allocate memory for responses, and so on. However, duplication of resources for use by each initiator bridge may consume IC device resources, which may be limited. Additionally, resources used by initiator bridges may vary based on varying access needs of tenants and/or users of initiator components, which may lead to an excess or shortage of resources if resources are not provisioned properly.

The present systems and techniques relate to embodiments for sharing resources of an IC device between communications pipelines of the IC device. In particular, embodiments of the present disclosure may include a universal bridge (e.g., universal bridge circuitry) that manages multiple communication pipelines between initiator components and target components. The universal bridge may include an MMIO initiator bridge for an MMIO communication pipeline, a streaming initiator bridge for a streaming communication pipeline, and a shared buffer that may be accessed by the MMIO initiator bridge and the streaming initiator bridge. The shared buffer may be provisioned such that the MMIO communication pipeline and the streaming communication pipeline operate independently of each other. Alternatively, the shared buffer may be provisioned and shared by each pipeline based on, for example, bandwidth consumption and/or latencies of the pipelines.

Further, the universal bridge may facilitate communications between initiator components and target components via virtual channels of a network on chip (NoC). As used herein, a virtual channel may be understood to mean a communication pathway or data stream between components of an IC device. For example, a NoC may facilitate virtual channels that carry information as a data stream between the universal bridge and an initiator component or target component. The universal bridge described herein may utilize a common virtual channel for communications of the streaming pipeline and, in some cases, may share use of the common virtual channel between the streaming pipeline and the MMIO pipeline. For example, a common virtual channel may carry streaming data from initiator components to target components, and the same virtual channel may carry responses from target components of the MMIO pipeline.

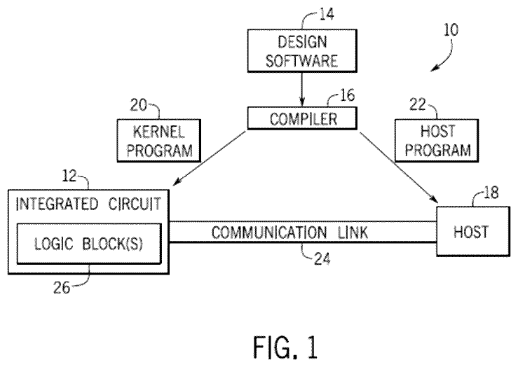

With the foregoing in mind, FIG. 1 illustrates a block diagram of a system 10 that may implement one or more functionalities. For example, a designer may desire to implement functionality, such as the operations of this disclosure, on an integrated circuit device 12 (e.g., a programmable logic device, such as a field programmable gate array (FPGA) or an application specific integrated circuit (ASIC)). In some cases, the designer may specify a high-level program to be implemented, such as an OpenCL® program or SYCL®, which may enable the designer to more efficiently and easily provide programming instructions to configure a set of programmable logic cells for the integrated circuit device 12 without specific knowledge of low-level hardware description languages (e.g., Verilog or VHDL). For example, since OpenCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

The designer may implement high-level designs using design software 14, such as a version of INTEL® QUARTUS® by INTEL CORPORATION. The design software 14 may use a compiler 16 to convert the high-level program into a lower-level description. In some embodiments, the compiler 16 and the design software 14 may be packaged into a single software application. The compiler 16 may provide machine-readable instructions representative of the high-level program to a host 18 and the integrated circuit device 12. The host 18 may receive a host program 22 which may be implemented by a kernel program 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel program 20 and the host 18 may enable configuration of one or more logic circuitry 26 on the integrated circuit device 12. The logic circuitry 26 may include circuitry and/or other logic elements and may implement arithmetic operations, such as addition and multiplication.

The designer may use the design software 14 to generate and/or to specify a low-level program, such as the low-level hardware description languages described above. For example, the design software 14 may be used to map a workload to one or more routing resources of the integrated circuit device 12 based on a timing, a wire usage, a logic utilization, and/or a routability. Additionally or alternatively, the design software 14 may be used to route first data to a portion of the integrated circuit device 12 and route second data, power, and clock signals to a second portion of the integrated circuit device 12. Moreover, in some embodiments, the techniques described herein may be implemented in circuitry as a non-programmable circuit design. Thus, embodiments described herein are intended to be illustrative and not limiting.

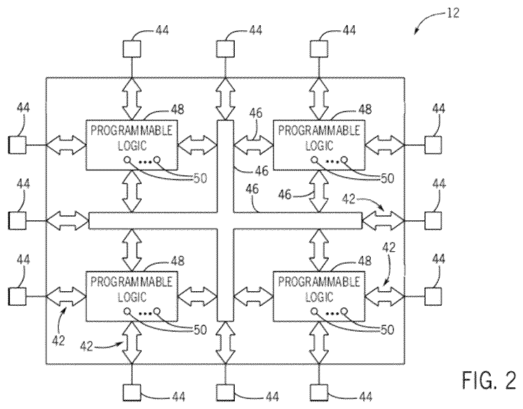

Turning now to a more detailed discussion of the integrated circuit device 12, FIG. 2 is a block diagram of an example of the integrated circuit device 12 as a programmable logic device, such as a field-programmable gate array (FPGA). Further, it should be understood that the integrated circuit device 12 may be any other suitable type of programmable logic device (e.g., a structured ASIC such as eASIC™ by Intel Corporation and/or application-specific standard product). The integrated circuit device 12 may have input/output circuitry 42 for driving signals off the device and for receiving signals from other devices via input/output pins 44. Interconnection resources 46, such as global and local vertical and horizontal conductive lines and buses, and/or configuration resources (e.g., hardwired couplings, logical couplings not implemented by designer logic), may be used to route signals on integrated circuit device 12. Additionally, interconnection resources 46 may include fixed interconnects (conductive lines) and programmable interconnects (i.e., programmable connections between respective fixed interconnects). For example, the interconnection resources 46 may be used to route signals, such as clock or data signals, through the integrated circuit device 12. Additionally or alternatively, the interconnection resources 46 may be used to route power (e.g., voltage) through the integrated circuit device 12. Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as the integrated circuit device 12, may include programmable elements 50 with the programmable logic 48. In some embodiments, at least some of the programmable elements 50 may be grouped into logic array blocks (LABs). As discussed above, a designer (e.g., a user, a customer) may (re) program (e.g., (re) configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program the programmable elements 50. In general, programmable elements 50 may be based on any suitable programmable technology, such as fuses, anti-fuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using input/output pins 44 and input/output circuitry 42. In one embodiment, the memory cells may be implemented as random-access-memory (RAM) cells. The use of memory cells based on RAM technology as described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 48. In some embodiments, the output signals may be applied to the gates of metal-oxide-semiconductor (MOS) transistors within the programmable logic 48.

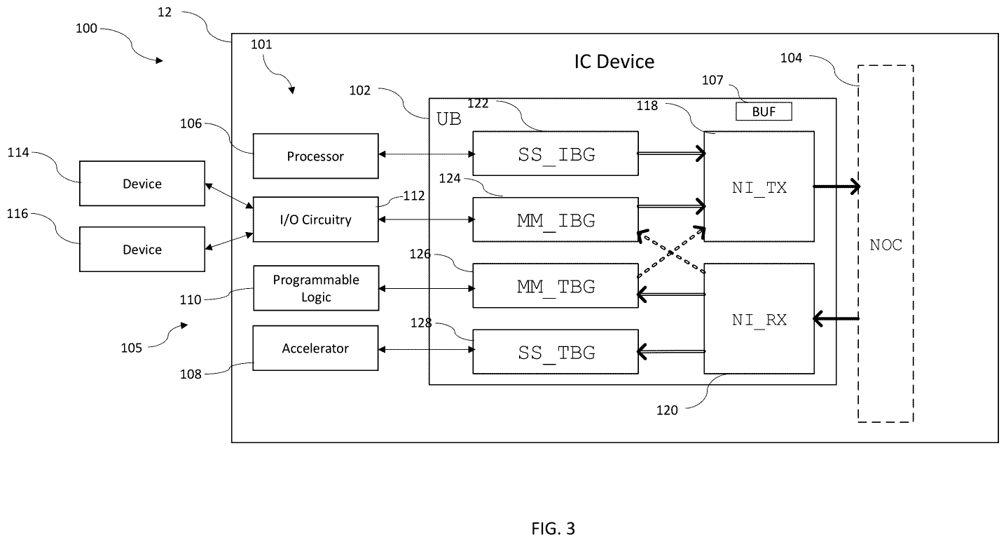

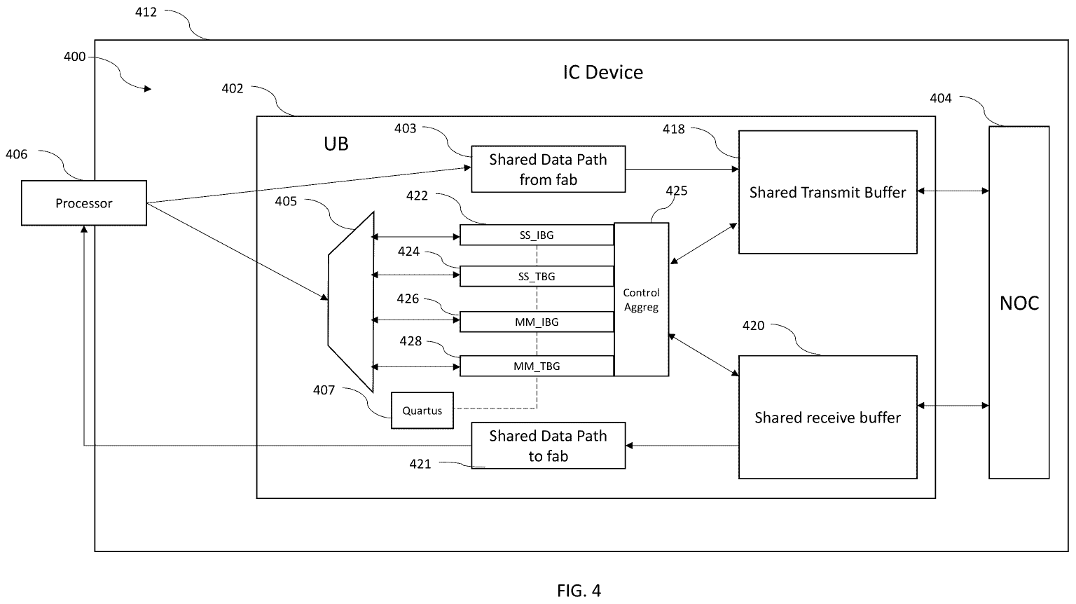

FIG. 3 is a block diagram of a system 100 in which initiator components 101 may access target components of the IC device 12 via a universal bridge 102 that communicates with a NoC 104. As illustrated, the initiator components 101 may include a processor 106 that accesses target components of the IC device 12, here illustrated as an accelerator 108 and programmable logic 110 based on instructions from tenants of the processor 106, such as an application or execution environment. Likewise, I/O circuitry 112 may allow access to the accelerator 108 and/or the programmable logic 110 by a first device 114 and/or a second device 116, which may represent any suitable computing device connected to the IC device 12. The illustrated target components may perform a specific function to aid the initiator components in performing the specific function. For example, the accelerator 108 may perform a computation function independently from the processor 106 and/or more efficiently than another hardware or software component and, thus, the processor 106 may instruct (e.g., drive) the accelerator 108 to perform the function as needed.

To facilitate communication between the initiator components 101 and the target components 105, the universal bridge 102 may include an initiator bridge 122 or 124 for each initiator component 106 and 112 and a target bridge 126 or 128 for each target component 108 and 110. The universal bridge 102 may also include a transmit packet switch 118 that routes communications from the initiator bridges to the NoC 104 based on a communication type and a receive packet switch 120 that routes communications from the NoC to the target bridges based on a communication type. For example, the receive packet switch 120 may route a communication to a particular target bridge based on a packet format of a received communication. If a communication is a response packet, for instance, the receive packet switch 120 may route the communication to an MMIO target bridge.

In the illustrated example, the universal bridge 102 includes a streaming initiator bridge 122 that routes streaming data (e.g., requests) from the processor 106 to a target bridge (e.g., the streaming target bridge 128) via the transmit packet switch 118 and the NoC 104. The universal bridge 102 also includes a MMIO initiator bridge 124 that may map a request from the I/O circuitry 112 to a memory address (e.g., an address associated with the programmable logic 110), determine a security attribute of the request based on the mapping, send the request to a corresponding target component 108 or 110 via the transmit packet switch 118, receive responses via the receive packet switch 120, store the responses in a buffer 107, reorder the responses within the buffer 107, and transmit the responses to the I/O circuitry 112.

Additionally, the universal bridge 102 may include a MMIO target bridge 126 that routes communications (e.g., requests) received via the receive packet switch 120 to the programmable logic 110. In some embodiments, the MMIO target bridge 126 may also route responses from the programmable logic 110 to an initiator bridge 122 and/or 124 via the transmit packet switch 118. The universal bridge 102 also includes a streaming target bridge 128. The streaming target bridge 128 may manage buffers to accept incoming data from an initiator bridge (e.g., the initiator bridge 122), verify that a target component (e.g., the accelerator 108) is prepared to receive the data, and manage credits associated with an initiator bridge (e.g., the streaming initiator bridge 122) and/or an initiator component (e.g., the processor 106). As used herein, a credit may be issued to an initiator component or initiator bridge, and the credit may represent a portion of memory allocated to the initiator component. An initiator component 106 or 112 may consume a credit when memory is allocated for a process of the initiator component 106 or 112, and the credit may be replenished when the memory is no longer used by the initiator component 106 or 112. Credits may be distributed to initiator components 106 or 112 and/or initiator bridges 122 or 124 according to a configuration of the IC device 12 that may be based on bandwidth considerations, a priority hierarchy, or the like.

FIG. 4 is a block diagram of a system 400 in which a processor 406 may access an accelerator 408 via a universal bridge 402 that communicates with a NoC 40. A shared transmit buffer 418 may store, for example, requests received from the processor 406 via a first shared data path 403, and a shared receive buffer 420 may store responses received via the NoC 40. The responses stored in the shared receive buffer 420 may be sent to the processor 406 along a second shared data path 421. The first shared data path 403 and the second shared data path 421 may be shared between multiple communication protocols (e.g., MMIO and streaming protocols) and/or multiple initiator components and target components.

In the illustrated embodiment, the processor 406 may send a communication (e.g., data packet) along a first shared data path 403 to a shared transmit buffer 418. The communication sent from by processor 406 may also be interpreted by a multiplexer 405. The multiplexer 405 may determine, based on characteristics of the communication (e.g., metadata) and instructions received from a programming tool 407, whether the communication corresponds to an MMIO protocol or a streaming protocol. The instructions received from the programming tool 407 may define, for example, a persona of a streaming initiator bridge 422, a streaming target bridge 424, an MMIO initiator bridge 426, and a MMIO target bridge 428 based on, for example, usage expectations of one or more communications protocols. The multiplexer 405 may also determine whether the communication corresponds to an initiator component or a target component. Based on whether the communication corresponds to the MMIO protocol or the streaming protocol and whether the communication corresponds to an initiator component or a target component, the multiplexer 405 may route the communication to the streaming initiator bridge 422, the streaming target bridge 424, the MMIO initiator bridge 426, or the MMIO target bridge 428. In the illustrated example, the communication from the processor 406 may correspond to an initiator component and an MMIO protocol.

The streaming initiator bridge 422, a streaming target bridge 424, an MMIO initiator bridge 426, and the MMIO target bridge 428 may generate one or more control signals, and aggregation circuitry 425 may aggregate the one or more control signals to control the shared transmit buffer 418 and/or a shared receive buffer 420. The controls may, for example, determine an allocation of the shared transmit buffer 418 (e.g., between an MMIO protocol and a streaming protocol) and a shared receive buffer 420. For example, the shared receive buffer 420 may be allocated between an MMIO protocol and a streaming protocol based on the one or more control signals received from the aggregation circuitry 425.

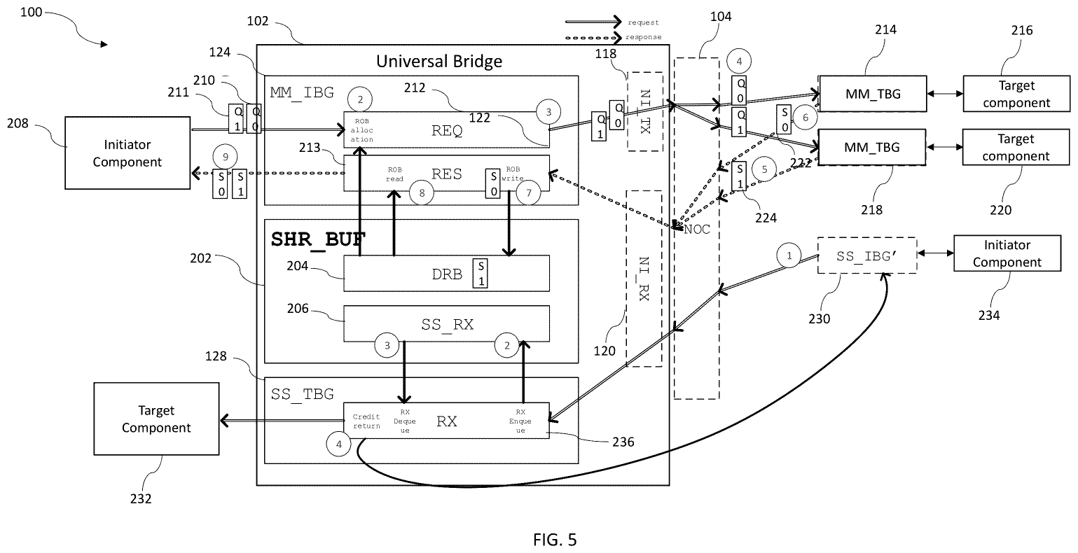

FIG. 5 is a block diagram of the system 100 in which the MMIO initiator bridge 124 and the streaming target bridge 128 share use of a shared buffer 202. In particular, while the shared buffer 202 is illustrated as one buffer, the shared buffer 202 may be provisioned such that it may be used for both MMIO functionalities by the MMIO initiator bridge 124 and streaming functionalities by the streaming target bridge 128. In the illustrated example, the shared buffer 202 acts as both a data response buffer 204 that is accessed by the MMIO initiator bridge 124 and a received streaming data buffer 206 that is accessed by the streaming target bridge 128. While the shared buffer 202 is illustrated as acting as the data response buffer 204 and the streaming data buffer 206, the shared buffer 202 may store other data or perform other functionalities for various target bridges and initiator bridges. In particular, memory portions of the shared buffer 202 may be allocated to initiator bridges and target bridges according to design considerations of the universal bridge 102. For example, a data response buffer 204 of the shared buffer 202 may be sized based on a bandwidth and/or frequency of an associated initiator bridge and a latency between the initiator bridge and target components. As such, the shared buffer 202 may be configurable according to various communication protocols, bandwidths, latencies, and so on of the universal bridge 102.

The MMIO initiator bridge 124 may access the data response buffer 204 to facilitate MMIO communications between an initiator component 208, which may represent the processor 106 or the I/O circuitry 112 of FIG. 3, and a target component. To illustrate, the initiator component 208 may send a first request 210 and a second request 211 to the MMIO initiator bridge 124, where it is received at request circuitry 212. It should be noted that, based on the order by which the first request 210 and second request 211 were sent, the initiator component may expect to receive a response to the first request 210 prior to receiving a response to the second request 211. In response to receiving the first and second requests 210 and 211, the request circuitry 212 may allocate a portion of the data response buffer 204 for the first and second requests 210 and 211. The request circuitry 212 may then route the first request 210 and the second request 211 to the NoC 104 via the transmit packet switch 118, and the NoC 104 may deliver the first request 210 to a first MMIO target bridge 214 and may deliver the second request 211 to a second MMIO target bridge 218. Finally, the first MMIO target bridge 214 may route the first request 210 to a first target component 216, and the second MMIO target bridge 218 may route the second request 211 to a second target component 220.

In the illustrated example, the second target component 220 may respond to the second request 211 before the first target component 216 responds to the first request 210 based on a computation delay or other timing variability. A first response 222 to the first request 210 and a second response 224 to the second request 211 may be routed from the respective target bridges to response circuitry 213 of the MMIO initiator bridge 124 via the NoC 104 and the receive packet switch 120.

As mentioned, based on the order by which the first request 210 and second request 211 were sent, the initiator component may be prepared to receive the first response 222 prior to receiving the second response 224. With this in mind, the response circuitry 213 may reorder received responses by using the data response buffer 204 to reorder responses in an order expected by an initiator component. That is, the response circuitry 213 may use the data response buffer 204 as a reorder buffer. Accordingly, when the second response 224 is received at the response circuitry 213 (e.g., before the first response 222 is received), the response circuitry 213 may store the second response 224 in the data response buffer 204, as illustrated. When the first response 222 is received, the first response 222 may be forwarded to the initiator component 208. Additionally, the second response 224 may be retrieved from the data response buffer 204 and sent to the initiator component 208. As such, storing the second response 224 in the data response buffer 204 may allow the MMIO initiator bridge 124 to send responses to the initiator component 208 in an expected order.

Further, in addition to reordering purposes of the data response buffer 204, the response circuitry 213 may utilize the shared buffer 202 for other communication purposes. For example, the response circuitry 213 may utilize the data response buffer 204 to temporarily store responses when an initiator component is unable to receive the responses. As such, the data response buffer 204 may be used to alleviate backpressure on the response pipeline.

The streaming target bridge 128 may access the shared buffer 202 to facilitate streaming communications (e.g., requests) between an initiator bridge 230 and a target component 232. While one initiator bridge 230 is illustrated as communicating with the streaming target bridge 128, in some examples, multiple (e.g., 5, 10, 100) initiator bridges may communicate with the streaming target bridge 128. Likewise, while the target streaming bridge is illustrated as sending communications to one target component, in some examples, the streaming target bridge 128 may facilitate communication to and from multiple target components.

In the illustrated example, the initiator bridge 230 may attempt to send a communication originating from an initiator component 234 which may represent, for example, the processor 106 of FIG. 3. The initiator bridge 230 may determine whether credits corresponding to a portion of the streaming data buffer 206 are available before sending a communication to receive circuitry 236 of the streaming target bridge 128. In doing so, the initiator bridge 230 may verify that a portion of the streaming data buffer 206 is allocated for the initiator bridge 230 and available to write to. If credits are available, the initiator bridge 230 may send the communication to the receive circuitry 236 of the streaming target bridge 128 via the NoC 104 and the receive packet switch 120. In addition to sending the communication, the initiator bridge 230 may discard or destroy the credit or, alternatively, may send the credit (e.g., as data) to the streaming target bridge 128 for further consideration or manipulation. By verifying that a portion of the streaming data buffer 206 is allocated and available, networking issues (e.g., invalid writes, data integrity and concurrency issues, memory leaks, congestion within the NoC 104) that may result from delays at a target component or elsewhere in the system 100 may be mitigated. Further, such a credit system may mitigate such issues while allowing a common virtual channel for all incoming streaming data.

The receive circuitry 236 may store the received communication in the streaming data buffer 206 of the shared buffer 202. The receive circuitry 236 may then determine whether the target component 232 is ready and/or available to receive the communication stored in the streaming data buffer 206 based on, for example, a received indication from the target component 232 or by periodically querying the target component for a status. In response to determining that the target component 232 is ready to receive the communication, the receive circuitry 236 may retrieve the communication from the streaming data buffer 206 and route the communication to the target component, making available (e.g., freeing) the portion of the streaming data buffer 206 that was occupied by the communication. In response, the receive circuitry 236 may issue, reissue, or return a credit to the initiator bridge 230, indicating that the portion of the streaming data buffer 206 that was occupied by the communication is now available for further writes (e.g., to receive additional communications from the initiator bridge 230).

Additional implementations of resource sharing between MMIO and streaming pipelines are envisioned. For example, each of the MMIO initiator bridge 124, the streaming target bridge 128, and/or the streaming initiator bridge 230 may utilize flip flops or other circuitry for writing data to the buffers discussed herein, reading data from the buffers, or other networking operations. In an example, the universal bridge 102 may include common flip flops that may be utilized for writing data by the MMIO initiator bridge 124 and for streaming data by the streaming initiator bridge 122. Additionally or alternatively, the common flip flops may be utilized for reading data by the MMIO initiator bridge 124 and for streaming data by the streaming target bridge 128.

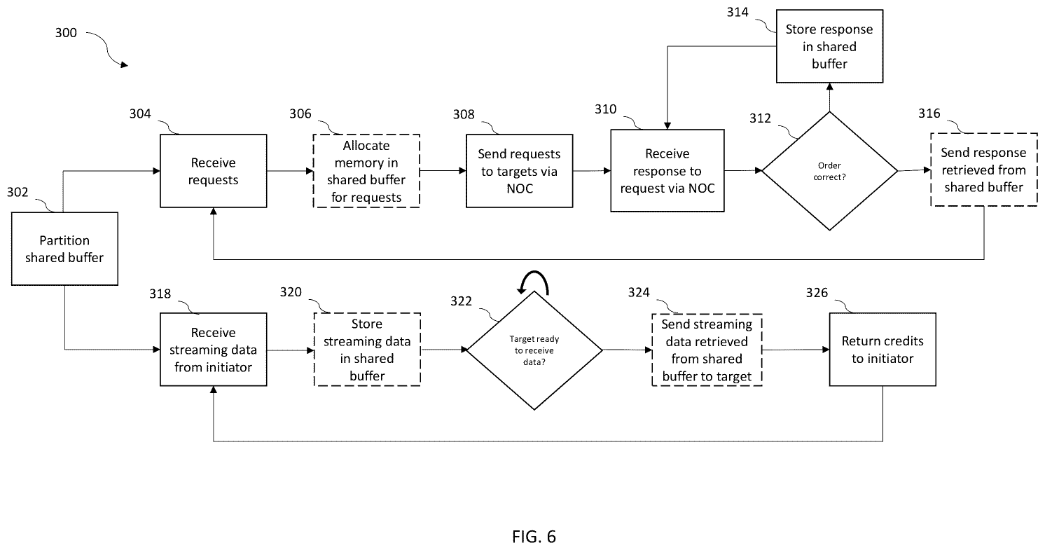

FIG. 6 is a flow chart of a method 300 for sharing resources of an IC device between communications pipelines of the IC device. The method may begin, in block 302, by partitioning the shared buffer 202 and other shared resources between communications pipelines of the IC device, such as an MMIO pipeline and a streaming pipeline that each facilitate communication between initiator components and target components. As discussed herein, memory portions of the shared buffer 202 may be allocated to initiator bridges and target bridges according to design considerations of the universal bridge 102. For example, a data response buffer of the shared buffer 202 may be sized based on a bandwidth and/or frequency of an associated initiator bridge and a latency between the initiator bridge and target components. As such, the shared buffer 202 may be configurable according to various communication protocols, bandwidths, latencies, and so on of the universal bridge 102.

In block 304, the request circuitry 212 of the MMIO initiator bridge of the universal bridge 102 may receive requests (e.g., the first request 210 and the second request 211) from the initiator component 208. In response to receiving the requests, the request circuitry 212 may, in block 306, allocate a portion of the data response buffer 204 for the requests. The request circuitry 212 may then, in block 308, send the requests to the NoC 104 via the transmit packet switch 118, the NoC 104 may deliver the requests to corresponding target bridges (e.g., the first MMIO target bridge 214 and the second MMIO target bridge 218), and the corresponding target bridges may route the requests to corresponding target components (e.g., the first target component 216 and the second target component 220).

In block 310, the response circuitry 213 of the MMIO initiator bridge 124 of the universal bridge 102 may receive responses (e.g., the first and second responses 222 and 224) to the requests sent to the corresponding target bridges via the NoC 104. As mentioned, based on the order by which the requests were sent by an initiator component, the initiator component may expect to receive the responses in a certain order. For example, in a first-in, first-out implementation, the initiator component may expect to receive responses to requests in the same order by which the requests were sent. Accordingly, in block 312, the response circuitry 213 may determine whether a received response should be stored in the data response buffer 204, in block 314, or if a response should be retrieved from the data response buffer 204 and sent to the initiator component 208 in block 316. After sending the received responses, the MMIO initiator bridge may continue to receive requests from the initiator component 208 in block 304.

In block 318, the receive circuitry 236 of the streaming target bridge 128 of the universal bridge 102 may receive streaming data (e.g., communications) originating from an initiator bridge (e.g., the streaming initiator bridge 230). As mentioned, the streaming data may be received via the receive packet switch 120 and the NoC 104. In block 320, the receive circuitry 236 may store the received data in the streaming data buffer 206 of the shared buffer 202. The receive circuitry 236 may then determine, in block 322, whether a target component of the data (e.g., the target component 232) is ready and/or available to receive the data stored in the streaming data buffer 206 based on, for example, a received indication from the target component 232 or by periodically querying the target component for a status. In response to determining that the target component 232 is ready to receive the data, the receive circuitry 236 may, in block 324, retrieve the data from the streaming data buffer 206 and route the data to the target component, making available (e.g., freeing) the portion of the streaming data buffer 206 that was occupied by the data. In response, the receive circuitry 236 may issue, reissue, or return a credit to the initiator bridge 230 in block 326, indicating that the portion of the streaming data buffer 206 that was occupied by the data is now available for further writes (e.g., to receive additional communications from the initiator bridge 230). The receive circuitry 236 may then continue to receive streaming data originating from an initiator bridge in block 318.

As described herein, different communication pipelines of the universal bridge 102 may be facilitated, and may access shared resources, concurrently. As such, resources of the IC device may be conserved. For example, in the method 300, the blocks 304, 306, 308, 310, 312, 314, and 316 (e.g., the MMIO pipeline) and the blocks 318, 320, 322, 324, and 326 (e.g., the streaming pipeline) may include concurrent or shared access to the shared buffer 202. As discussed, the techniques herein may also include sharing additional resources of an IC device, such as shared read flip flops and/or write flip flops, to facilitate various communication protocols.

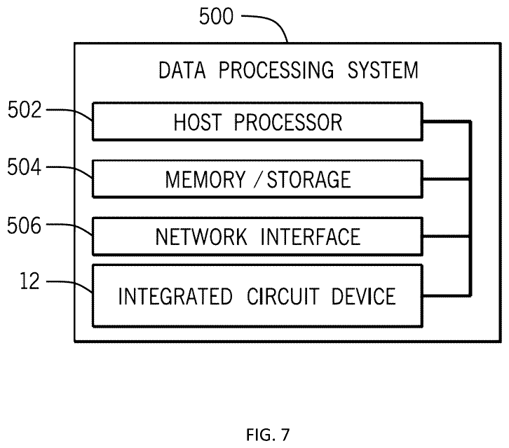

An integrated circuit device including the universal bridge of this disclosure may represent or be part of a data processing system, such as a data processing system 500, shown in FIG. 7. The data processing system 500 may include the integrated circuit device 12 (e.g., a programmable logic device, an ASIC, a processor), a host processor 502, memory and/or storage circuitry 504, or a network interface 506. The clock drift control system of this disclosure may be part of the integrated circuit system 12 (e.g., a programmable logic device), the host processor 502, the memory and/or storage circuitry 504, or the network interface 506, or another integrated circuit such as a graphics processing unit (GPU) or AI application specific integrated circuit (ASIC). The data processing system 500 may include more or fewer components (e.g., electronic display, user interface structures, application specific integrated circuits (ASICs)). The host processor 502 may include any processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams, mapping function) for programming the integrated circuit device 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as different cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

### EXAMPLE EMBODIMENTS

EXAMPLE EMBODIMENT 1. A method, comprising; receiving a request from a first initiator component, the request associated with a first communication protocol; storing the request in a shared buffer; receiving a response from a first target component, the response associated with a second communication protocol; storing the response in the shared buffer; sending the request from the shared buffer to a second target component; and sending the response from the shared buffer to a second initiator component.

EXAMPLE EMBODIMENT 2. The method of example embodiment 1, wherein the first communication protocol comprises a data streaming communication protocol.

EXAMPLE EMBODIMENT 3. The method of example embodiment 1, wherein the second communication protocol comprises a memory-mapped input/output (MMIO) protocol.

EXAMPLE EMBODIMENT 4. The method of example embodiment 1, comprising: receiving an additional request from the second initiator component, the additional request associated with the second communication protocol; allocating a portion of the shared buffer in response to receiving the additional request; and sending the additional request to the first target component, wherein the first target component is configured to generate the response in response to receiving the additional request, wherein the response is stored in the allocated portion of the shared buffer.

EXAMPLE EMBODIMENT 5. The method of example embodiment 4, wherein the response is sent from the shared buffer to the second initiator component based on an order by which the additional request is received.

EXAMPLE EMBODIMENT 6. The method of example embodiment 1, comprising: receiving an indication that the second target component is prepared to receive the request, wherein the request is sent from the shared buffer to the second target component in response to the indication.

EXAMPLE EMBODIMENT 7. The method of example embodiment 1, comprising: determining that the request is associated with the first communication protocol based on a first packet type of the request; and determining that the response is associated with the second communication protocol based on a second packet type of the response, the second packet type different than the first packet type.

EXAMPLE EMBODIMENT 8. The method of example embodiment 1, comprising: issuing a credit to the first initiator component in response to sending the response from the shared buffer to the second initiator component, the credit indicating that a portion of the shared buffer has been made available.

EXAMPLE EMBODIMENT 9. The method of example embodiment 1, comprising: allocating a first portion of the shared buffer for the first communication protocol; and allocating a second portion of the shared buffer for the second communication protocol.

EXAMPLE EMBODIMENT 10. An integrated circuit, comprising: universal bridge circuitry, comprising: a shared buffer; first bridge circuitry configured to: receive first data from a first target component; store the first data in the shared buffer; and send the first data from the shared buffer to a first initiator component; and second bridge circuitry configured to: receive second data from a second initiator component; store the second data in the shared buffer; and send the second data from the shared buffer to a second target component.

EXAMPLE EMBODIMENT 11. The integrated circuit of example embodiment 10, wherein the universal bridge circuitry comprises: a packet switch configured to: receive the first data and the second data; route the first data to the first bridge circuitry based on a first packet type of the first data; and route the second data to the second bridge circuitry based on a second packet type of the second data, the second packet type different than the first packet type.

EXAMPLE EMBODIMENT 12. The integrated circuit of example embodiment 10, comprising: a network on chip (NoC) configured to: route the first data from the first target component to the first bridge circuitry; and route the second data from the second initiator component to the second bridge circuitry.

EXAMPLE EMBODIMENT 13. The integrated circuit of example embodiment 12, wherein the NoC is configured to route the first data and the second data on a common virtual channel.

EXAMPLE EMBODIMENT 14. The integrated circuit of example embodiment 10, wherein the shared buffer comprises: a first allocation associated with the first bridge circuitry; and a second allocation associated with the second bridge circuitry, wherein the first bridge circuitry is configured to store the first data in the first allocation, and wherein the second bridge circuitry is configured to store the second data in the second allocation.

EXAMPLE EMBODIMENT 15. The integrated circuit of example embodiment 10, comprising the first target component, the first initiator component, the second initiator component, and the second target component.

EXAMPLE EMBODIMENT 16. The integrated circuit of example embodiment 10, wherein the first data comprises a response to a memory-mapped input/output (MMIO) communication protocol request, and wherein the second data comprises a streaming communication protocol request.

EXAMPLE EMBODIMENT 17. A tangible, non-transitory, and computer-readable medium, storing instructions thereon, wherein the instructions, when executed, are to cause a processor to: receive a request from a first initiator component; store the request in a first allocation of a shared buffer; receive a response from a first target component; store the response in a second allocation of the shared buffer; send the request from the first allocation of the shared buffer to a second target component; and send the response from the second allocation of the shared buffer to a second initiator component.

EXAMPLE EMBODIMENT 18. The tangible, non-transitory, and computer-readable medium of example embodiment 17, wherein the first allocation is associated with a first communication protocol of the request, and wherein the second allocation is associated with a second communication protocol of the response.

EXAMPLE EMBODIMENT 19. The tangible, non-transitory, and computer-readable medium of example embodiment 17, wherein the second allocation is configured to store one or more additional responses, and wherein the instructions, when executed, are to cause the processor to: send the response and the one or more additional responses from the second allocation of the shared buffer to the second initiator component based on an order by which the second initiator component is configured to receive the response and the one or more additional responses.

EXAMPLE EMBODIMENT 20. The tangible, non-transitory, and computer-readable medium of example embodiment 17, wherein the instructions, when executed, are to cause the processor to: receive an indication that the second target component is prepared to receive the request; and send the request from the second allocation of the shared buffer to the second initiator component based on the indication.

What is claimed is:

1. A method, comprising;
receiving a request from a first initiator component, the request associated with a first communication protocol;
storing the request in a shared buffer;
receiving a response from a first target component, the response associated with a second communication protocol;
storing the response in the shared buffer;
sending the request from the shared buffer to a second target component; and
sending the response from the shared buffer to a second initiator component.

2. The method of claim 1, wherein the first communication protocol comprises a data streaming communication protocol.

3. The method of claim 2, wherein the second communication protocol comprises a memory-mapped input/output (MMIO) protocol.

4. The method of claim 1, comprising:
receiving an additional request from the second initiator component, the additional request associated with the second communication protocol;
allocating a portion of the shared buffer in response to receiving the additional request; and
sending the additional request to the first target component, wherein the first target component is configured to generate the response in response to receiving the additional request, wherein the response is stored in the allocated portion of the shared buffer.

5. The method of claim 4, wherein the response is sent from the shared buffer to the second initiator component based on an order by which the additional request is received.

6. The method of claim 1, comprising:
receiving an indication that the second target component is prepared to receive the request, wherein the request is sent from the shared buffer to the second target component in response to the indication.

7. The method of claim 1, comprising:
determining that the request is associated with the first communication protocol based on a first packet type of the request; and
determining that the response is associated with the second communication protocol based on a second packet type of the response, the second packet type different than the first packet type.

8. The method of claim 1, comprising:
issuing a credit to the first initiator component in response to sending the response from the shared buffer to the second initiator component, the credit indicating that a portion of the shared buffer has been made available.

9. The method of claim 1, comprising:
allocating a first portion of the shared buffer for the first communication protocol; and
allocating a second portion of the shared buffer for the second communication protocol.

10. An integrated circuit, comprising:
universal bridge circuitry, comprising:
a shared buffer;
first bridge circuitry configured to:
receive first data from a first target component;
store the first data in the shared buffer; and
send the first data from the shared buffer to a first initiator component; and
second bridge circuitry configured to:
receive second data from a second initiator component;
store the second data in the shared buffer; and
send the second data from the shared buffer to a second target component.

11. The integrated circuit of claim 10, wherein the universal bridge circuitry comprises:
a packet switch configured to:
receive the first data and the second data;
route the first data to the first bridge circuitry based on a first packet type of the first data; and
route the second data to the second bridge circuitry based on a second packet type of the second data, the second packet type different than the first packet type.

12. The integrated circuit of claim 10, comprising:
a network on chip (NoC) configured to:
route the first data from the first target component to the first bridge circuitry; and
route the second data from the second initiator component to the second bridge circuitry.

13. The integrated circuit of claim 12, wherein the NoC is configured to route the first data and the second data on a common virtual channel.

14. The integrated circuit of claim 10, wherein the shared buffer comprises:
a first allocation associated with the first bridge circuitry; and
a second allocation associated with the second bridge circuitry, wherein the first bridge circuitry is configured to store the first data in the first allocation, and wherein the second bridge circuitry is configured to store the second data in the second allocation.

15. The integrated circuit of claim 10, comprising the first target component, the first initiator component, the second initiator component, and the second target component.

16. The integrated circuit of claim 10, wherein the first data comprises a response to a memory-mapped input/output (MMIO) communication protocol request, and wherein the second data comprises a streaming communication protocol request.

17. A tangible, non-transitory, and computer-readable medium, storing instructions thereon, wherein the instructions, when executed, are to cause a processor to:
receive a request from a first initiator component;
store the request in a first allocation of a shared buffer;
receive a response from a first target component;
store the response in a second allocation of the shared buffer;
send the request from the first allocation of the shared buffer to a second target component; and
send the response from the second allocation of the shared buffer to a second initiator component.

18. The tangible, non-transitory, and computer-readable medium of claim 17, wherein the first allocation is associated with a first communication protocol of the request, and wherein the second allocation is associated with a second communication protocol of the response.

19. The tangible, non-transitory, and computer-readable medium of claim 17, wherein the second allocation is configured to store one or more additional responses, and wherein the instructions, when executed, are to cause the processor to:
send the response and the one or more additional responses from the second allocation of the shared buffer to the second initiator component based on an order by which the second initiator component is configured to receive the response and the one or more additional responses.

20. The tangible, non-transitory, and computer-readable medium of claim 17, wherein the instructions, when executed, are to cause the processor to:
receive an indication that the second target component is prepared to receive the request; and
send the request from the second allocation of the shared buffer to the second initiator component based on the indication.
